(19) United States
(12) Patent Application Publication
(10) Pub. No.: US 2026/0338812 A1
(43) Pub. Date: Oct. 29, 2026

(54) Automated device and module for performing chemical and/or biological experiments

(71) Applicant: mo:re GmbH, Hamburg (DE)

(72) Inventors: David HACKENBERGER, Hamburg (DE); Lukas GAATS, Hamburg (DE); Mauro Filipe MONTEIRO PEIXE, Setubal (PT); Philipp DEPPERSCHMIDT, Hamburg (DE)

(21) Appl. No.: 19/486,527

(22) PCT Filed: May 25, 2024
(86) PCT No.: PCT/EP2024/064463

§ 371 Date: Nov. 21, 2025

(30) Foreign Application Priority Data
May 25, 2023 (LU) LU103130

(51) Int. Cl. G01N 35/00; B01L 9/00; G01N 35/02; G01N 35/04; G01N 35/10

(52) U.S. Cl. CPC G01N 35/00871; B01L 9/523; G01N 35/0099; G01N 35/028; G01N 35/109; B01L 2200/025; B01L 2200/18; B01L 2300/0627; B01L 2300/0829; G01N 2035/00356; G01N 2035/00524; G01N 2035/0427; G01N 2035/0477; G01N 2035/0498

(57) ABSTRACT

The invention relates to an automated device (1.1) for performing chemical and/or biological experiments and a module (1.13) set up to receive and store a sample carrier (1.11) used in chemical and/or biological experiments whereby the automated device (1.1) and the module (1.13) are operatively connected to each other in such a way that the efficiency of the experiment and the handling of the sample carriers is improved compared to the state of the art. This is achieved by a magnetic interaction between the automated device (1.1) and the module (1.13).

### TECHNICAL AREA

The present invention relates to an automated device for performing chemical and/or biological experiments and a module set up to receive and store a sample carrier used in chemical and/or biological experiments.

### STATE OF THE ART

Conventional automated pipetting systems are widely used in laboratories. They automate the pipetting of liquids, which improves accuracy and reduces the workload of laboratory personnel. However, these conventional automated pipettors are designed for specific tasks and offer limited flexibility in terms of their functions. Despite their advantages, for example high throughput and reproducibility in highly automated und parallel processes, however, existing automated pipetting systems have several limitations.

Commonly, automated pipettors are limited to specific pipetting protocols and tasks and require special adaptations or new equipment for different requirements. This can limit the flexibility of the laboratory and lead to higher costs. Furthermore, automated pipetting systems are mostly complex to operate, especially if they have to be configured for different tasks. This can lead to errors and requires extensive training of the operating personnel. A commonly encountered challenge is the integration of automated pipetting systems into existing laboratory infrastructures and processes, especially if data has to be exchanged between different devices and systems. Especially for smaller facilities and companies, many automated pipetting systems are too large, take up valuable laboratory space and are often an expensive investment. Specified functionality in particular can lead to high costs and application limitations. In addition, maintenance and operating costs as well as costs of consumables and accessories can be significant.

In laboratory automation, and especially in automated pipetting systems, a variety of technologies and methods already exist that are used to solve different tasks. Frequently, these are stand-alone devices with firmly defined functions and limited flexibility with regard to adaptation to different tasks or expandability with new functions.

The state of the art includes, for example, devices with permanently installed pipetting heads that can transfer a certain number of samples into predefined formats. Such devices are often designed to process standard plate formats such as microtiter plates and offer only limited possibilities for adaptation to other formats or requirements.

Some automated pipetting systems offer the ability to use different tools or pipetting systems to allow greater flexibility in sample processing. However, this often requires manual changing of tools or pipetting systems and can therefore be time-consuming and error prone. Furthermore, these puts the product or operator at risk of contamination, especially in the production of GMP certified pharmaceuticals or biotechnological products. There are also systems that offer flexibility in sample handling through the use of robots. These devices can often perform a variety of different tasks but are usually very complex and require a great deal of programming and setup.

The patent specification WO 2002/049 761 A2 discloses an automated laboratory system and method for high throughput and fully automated processing of materials, including liquids and genetic materials. It further discloses a storage unit and a conveyor system with hooks for transporting materials. A major disadvantage of this system is the space required and the mechanical complexity since the conveyor system and processing means are located in two different systems.

The document CN 209205330 U relates to a mechanical arm experiment system characterized by comprising an experiment stem, an X-axis mechanical arm, a Y-axis mechanical arm, a Z-axis arm, a mould assembly, a stage member, and an electrical control unit. This system allows for a mechanical arm to carry a tool mold group capable of performing automated tasks. While this allows for some flexibility in the design of different experiments, all the modules need to be preinstalled and customized in order to be manipulated with tool mould group.

Patent specification CN 103846114 A describes an automated pipetting attachment for parallel and low-vibration manipulation of liquids. This allows multiple pipetting passes to be performed in parallel in a single run, enabling high throughput automation. However, to perform additional tasks, such a system must be coupled with another system, which adds cost and space.

The patent specification KR 10-1854807 B1 describes an automated, unmanned cell culture system consisting of an incubator for housing multiple cell culture flasks and various work areas such as a tube table and centrifugal separator, and a transport and manipulation system. While this system allows for autonomous cell culture cultivation, it is limited to this task and does not allow for customization of the modules.

The patent specification WO 2019/232 504 A3 discloses a system, method, and devices for obtaining and preparing single cells, nuclei, subcellular components, and biomolecules from samples, including tissues. It also describes a multi-well system for cultivating aforementioned biological components. This disclosure is also limited in its scope and the extent of possible experimentation and does not provide means for customization.

Most existing systems are also limited in terms of integrating additional functions or adding new functions. Often, the integration of new functions requires the purchase and installation of additional equipment, which involves considerable cost and effort.

The document U.S. Pat. No. 11,199,560 B2 describes devices, systems, and methods for sample processing and analysis, specifically an analyzer that is part of a high-throughput system. The system can be configured in various ways to meet the diagnostic needs of a particular laboratory. The analyzer has multiple decks, including one for electronic components and consumable waste, and another for sample processing and analysis, which also stores consumables such as pipette tips and reagents. The system also includes a multipurpose robot with a Cartesian movement system, a vision system, a consumable gripper, and a multichannel pipettor.

The document U.S. Pat. No. 6,299,840 B1 describes a high automatic-operating-efficiency and high testing-accuracy in an automatic testing apparatus by minimizing the time required for transferring a specimen substrate between the mixing of the specimen with the reagent and the reaction therebetween. This is achieved by arranging the take-in area adjacent to the specimen holder area, thus reducing undesirable time loss and improving the efficiency and accuracy of the testing process. The patent also includes a specimen substrate stocking device with a take-out area arranged adjacent to the specimen holder area, further optimizing the transferring movement of the specimen substrate and minimizing undesirable time loss. The design of the magazine holder and the use of a U-shaped fixing member and bracket ensure easy exchange of the magazines, contributing to the overall efficiency of the system.

The document U.S. 2019/195902 A1 describes a reagent storage cabinet designed for operations performed by a robot. The cabinet includes a container accommodating portion for holding reagent containers and a storage cabinet main body with a front-surface opening portion for inserting and removing the container accommodating portion. The design allows the robot to directly access the reagents in the container when it is pulled out from the main body, enabling tasks such as dispensing work. The inner bottom surface of the container accommodating portion can be inclined, causing the reagent to gather in one direction as it is consumed, ensuring it is completely used up. The cabinet can also include a slide mechanism for automatic insertion and removal of the container accommodating portion, preventing spills. The reagent storage cabinet can be part of an automatic analyzing apparatus, providing efficient and complete use of reagents.

In summary, the state of the art in automated pipetting systems are characterized by a variety of devices, each of which can perform specific tasks, but are limited in their flexibility, adaptability, and expandability. Especially for smaller variable experiments, which are common in academic research and in smaller companies, the solutions found in the prior art are not well suited.

Based on the state of the art, in many fields, such as laboratory automation, cell culture production and medical drug development, users require different functionalities. These often require a new system, each with its own operating mechanisms. One object of the present invention is therefore to provide a highly flexible, modular system that meets the diverse functional requirements of experiments, preferably biological and/or biochemical and/or chemical experiments. The herein revealed automated device is designed to meet these requirements and provide a modular, automated, customizable solution with a standardized design.

The main problems with the current state of the art are lack of flexibility and modularity. With each new feature, a new system is usually required, resulting in significant cost, space requirements, and operational complexity. Alternatively, existing systems can be retooled or expanded. However, the lack of standardization prevents the seamless integration of different functions within an existing system.

For example, some solutions include robotic arms and/or actuators with pipette attachments as manipulators or offer the ability to customize automated pipettes and workbenches with different modules. However, to date, no solution offers a modular design with movable modules that can accommodate a variety of different experiments.

### OBJECTIVE OF THE INVENTION

The objective of the present invention is to provide a device and a module which enable flexible handling of sample carriers for use in chemical and/or biological experiments, whereby on the one hand flexible handling of the sample carriers is enabled and on the other hand the efficiency of the experiments is improved compared to the state of the art. Furthermore, it is the object of the present invention to be able to move a sample carrier safely and flexibly and to position and fix the sample carrier on a surface in preparation for an experiment or pipetting process.

### SOLUTION

The object of the invention is solved by providing magnetic means that enable flexible handling of sample carriers. Specifically, the present invention solves these problems by providing an automated device for performing chemical and/or biological experiments according to claim 1 or 11 and a module according to claim 5, whereby the automated device and the module are operatively connected to each other in such a way that the efficiency of the experiment and the handling of the sample carriers is improved compared to the state of the art. This is mainly achieved by a magnetic interaction between the automated device and the module.

Further advantageous embodiments can be found in the subclaims, the description and the embodiment examples.

### GENERAL ADVANTAGES

The present invention offers a number of advantages. The modular design of the device with different areas and quadrants allows for simultaneous or sequential execution of different experiment steps, leading to improved efficiency in carrying out chemical and/or biological experiments.

In one embodiment of the current invention, the device can be specifically tailored for conducting a variety of chemical and/or biological experiments or efficacy tests due to the variety of the modules and their flexible arrangement. The system can be adapted without need for manual interference by a lab technician. This enables a wide range of experimental applications and reduces risks of contamination.

In a preferred embodiment of the current invention, the movable actuator system facilitates the transportation of sample carriers containing cavities between different quadrants. It thus enables the transport of chemical substances and biological materials, providing efficient sample handling and transfer capabilities within the device. It further provides means by which the contents of the sample carrier can be manipulated, allowing a broad range of different experiments to be conducted.

In one aspect of the invention, the device incorporates a module for receiving and storing sample carriers, ensuring organized storage and easy retrieval of samples. The storage unit and transport unit combination allow for smooth insertion and removal of the sample carrier, facilitating streamlined workflow and reducing downtime. Furthermore, the conditions of the storage can be modified and controlled by sensors adapted for specific tasks. For example, the use of a fumigant allows for the manipulation of the storage unit gas composition.

In one embodiment, the transport unit of the device includes locking means, preferably electromagnetic connections, to ensure the reversible and stable securing of the sample carrier during transport and experimental processes. This feature prevents sample displacement or damage during movement, maintaining experimental integrity, while efficiently utilizing the limited space necessary to include such a system in a sterile work area, such as a sterile workbench. The transport unit allows for an optimization of the experimental flow.

### DETAILED DESCRIPTION

The current invention discloses an automated device for performing chemical and/or biological experiments, wherein the device comprises at least two areas, said areas being configured as at least one working area and at least one front loader area, each of said areas being divided into at least one quadrant.

The device comprises a movable actuator system which is attached to a trolly connected to a kinematic system, wherein a first movable actuator is being adapted to transport a sample carrier comprising at least one cavity from a first quadrant into a second quadrant or a further quadrant.

Furthermore, the device comprises at least one module adapted to receive and store the sample carrier, wherein a second movable actuator is adapted to fill the cavity with a volume of a chemical substance and/or a volume of a biological material and/or to remove at least partially the volume from the cavity when the sample carrier is positioned in the first quadrant or in the second quadrant or in the further quadrant, whereby the module is at least realized in a two part structure and has at least one first module part and at least one second module part, the first module part being designed as a storage unit and having an interior space, the interior space being set up to store the sample carrier and wherein a second module part is in operative connection with a first module part and/or the movable actuator system.

The second module part can be set up as a transport unit. Hence, the term second module part and transport can therefore be used equivalently herein.

Automation is understood to mean a process which can be carried out without the involvement of a human being. In particular preferred embodiment, the device according to the invention can be operated in an automated manner. For the automation, technical means, in particular means of data processing, are necessary, which are set up to control the device according to the invention or individual components of the device. Preferably, an automated process allows a human to intervene in the process at various times during the automated process (e.g., during the course of an experiment), for example, when consumables need to be refilled.

Another preferred aspect of the present invention is that the automation is robust, i.e., it requires little or no external input, such as the involvement of a human being, while performing an automated task, such as a chemistry and/or biology experiment. This has the technical advantage of requiring fewer personnel to monitor the experiment and reducing costs and contamination risks.

In the context of the current invention, biological experiments are understood to be processes involving biological material that is brought into contact with either chemical substances and/or biological material. In a preferred aspect of the present invention, these experiments include cell culture experiments and/or cell culture cultivation and/or drug screening assays and/or genomic sequencing and/or protein expression and purification and/or gene editing and/or enzyme activity and/or biochemical reactions.

Biological material refers to any substance derived from living organisms or containing components of living organisms can be cells of any kind, preferably such as cell suspensions, cell cultures, biological fluids, microorganisms, pathogenic microorganisms, viruses, genomic material, deoxy-or ribonucleic acids or proteins.

Chemical experiments are processes in which chemical substances (e.g. reactants) are brought into contact with each other to provoke chemical reactions. They can also be performed to identify chemical substances by reaction or by analysis using spectroscopic or other means.

A chemical substance is understood to be any molecule or molecular compound. In a preferred embodiment, liquid or dissolved chemical substances may be reacted and transferred.

In some embodiments of the device according to the present invention comprises at least two areas. An area denotes a spatial boundary, wherein the base area of the device according to the invention is divided into at least two areas. Preferably, the area is divided into at least one working area and at least one front loader area. In a preferred embodiment, the device comprises at least two areas, more preferably at least three areas. The areas may be placed interchangeably. There may also be at least one area in which consumables or cell culture media are stored.

The areas may be aligned parallel to each other. In some aspects of the invention, the areas may be accessed from above by a movable actuator system. The movable actuator system may be able to manipulate and/or transport modules placed on the areas.

In a preferred embodiment of the current invention, the areas are separated from each other, allowing for access from the side from a movable actuator system. Preferably, the areas are clearly demarcated from each other. In some embodiments, the demarcation is only visually, in a preferred embodiment the demarcation is by physical means, such as an elevation or cut out separating the different areas. Preferably, the demarcation is provided by a frame.

Furthermore, in an aspect of the invention related to an automated device comprising at least two areas, each of said areas being divided into at least one quadrant. A quadrant is an area that is delimited from another area. A quadrant can be congruent with a working area or a front loader area. Preferably, a first quadrant is the working area or a part thereof and a second quadrant is the front loader area or a part thereof. Further quadrants may also be provided, with the quadrants being congruent with further areas. The quadrants are preferably aligned parallel to each other and extend parallel to the base surface. The base surface has at least two quadrants, but preferably at least four quadrants.

The base surface can be subdivided into at least two quadrants.

In one embodiment of the module the module can be connected to a base surface of a device and/or to at least one further module, in particular via an electrically communicating connection, wherein the electrically communicating connection is set up for the transmission of data and/or electrical energy between the module and the base surface, especially between the module and a controller, and/or between the module and the further module.

Further preferably, a part of the quadrants, preferably at least four quadrants, is designed with the same area. In one aspect of the invention, quadrants designated with the same area, e.g., a front loader area or a working area, are arranged parallel to each other to form a row, which in turn are arranged parallel to another area, e.g., a front loader area or a working area.

Advantageously, this means that modules, containers, or consumables can be placed within any quadrant. The designation first, second and further quadrant are thereby preferably interchangeably usable, a module may be placed on any quadrant.

The working area is the area of the device in which the movable actuator acts and applies a biological material or a chemical substance to the sample carrier, in particular the cavity. For example, the wells of a microtiter plate can be filled with a cell suspension within the working area.

The front loader area is the area of the device, in which the module according to the invention is placed in, whereby the module contains the sample carrier. The front is the section of the module which, when used as intended, is closest to the movable actuator as soon as the latter removes the stowed transport unit from the module. The module is thus opened at the front by the movable actuator.

In a preferred embodiment of the current invention, the front loader area and the work area can be arranged interchangeable. This has the advantage that the areas can be arranged to allow efficient experimentation according to the desired modules. In one aspect of the present invention, in which no storage unit is required, two areas can be used as work areas.

In a preferred embodiment of the present invention comprises a movable actuator system, which consists of at least a first actuator and a second actuator. Preferably, the first and second actuator are mounted on a trolly, which can facilitate a horizontal movement.

In an alternative embodiment of the current invention, the actuator system provides a first movable actuator, which can be adapted to transport chemical substances and/or biological material and a second actuator providing means to fix and move transport units and/or modules.

The movable actuator system provides at least a first actuator and a second actuator. Particularly preferably, a movable actuator system consisting of at least two movable actuators is provided.

The movable actuator system consists of at least two actuators attached to a trolly connected to a kinematic system.

A trolly connected to a kinematic system refers to a mobile device equipped with wheels or rollers, integrated with a mechanical arrangement for motion transmission and control, enabling smooth and precise movement within a defined spatial framework. The kinematic system allows for a trolly to move in one spatial axis, such as the y axis, while moving itself on a second spatial axis, such as the x axis. The movement is preferably automatic. Especially preferably, the movement is performed automatically. Further preferably, the movement of the trolly connected to a kinematic system is driven by a controller.

In a preferred embodiment of the current invention, the movable actuator system is able to reach every area of the automated device. In a more preferred embodiment of the current invention, the first movable actuator can move a transport unit to any quadrant, especially preferably to any quadrant on the front loader area and/or working area.

A movable actuator (the first, the second, a further) and/or an movable actuator system is a means which can be moved in the three spatial axes x, y, and z. Preferably, the device according to the invention provides at least two movable actuators. More preferably, it provides at least a first and a second actuators, which can be adapted to facilitate different tasks. The movement is preferably automatic. Especially preferably, the movement is performed automatically. Further preferably, the movement of the movable actuator is driven by a controller. At least one means may be arranged on the movable actuator, which is arranged to convey chemical substances and/or biological material into or out of a cavity. For example, a movable actuator may be a robot on which pipettes are arranged. At least one movable actuator is adapted to transport the sample carrier and/or a chemical substance and/or a biological material and/or a consumable from one quadrant to another quadrant.

The designation first and second movable actuator are thereby preferably interchangeably usable and may be placed according to the installed modules. This has the advantage of optimizing the automation process by reducing process times by adapting the movable actuators according to the most frequently used modules in a desired configuration.

A first movable actuator is any actuator adapted to facilitate the movement of a sample carrier and/or transport unit between quadrants, such as from the first quadrant to a second quadrant or a further quadrant. The second movable actuator is adapted to contact the front of the transport unit at least for the duration of the transport of the transport unit from one quadrant to another.

A second movable actuator is any actuator which is adapted to fill the cavity with a volume of a chemical substance and/or a volume of a biological material and/or to remove at least partially the volume from the cavity when the sample carrier is positioned in the first quadrant or in the second quadrant or in the further quadrant.

According to a preferred embodiment of the current invention, a movable actuator can be adapted to manipulate the content of a sample carrier or transport unit, such as sample handling and transfer, precise positioning and placement of laboratory equipment, pipetting and dispensing of liquids, mixing and stirring solutions, centrifugation, temperature control, measurement and analysis, and other manipulations required for laboratory procedures and experiments.

In a particular preferred embodiment, the first movable actuator is providing magnetic positioning means, preferably magnets, more preferably electromagnets, most preferably a third magnetic means, which can be adapted to fix and safely move a transport unit and/or a module.

A sample carrier has at least one cavity. A sample carrier can be a cell culture plate, e.g. a microtiter plate, or Petri dish. A sample carrier can be a chemical reaction vessel, e.g. a test tube stand or an test tube holder. The sample carrier is adapted to be placed on a transport unit.

A cavity is understood to be a reaction and/or storage space which is enclosed by the sample carrier. The cavity can be filled or emptied with a liquid by the movable actuator or by means arranged on the movable actuator. In some cases, the cavity may be a test tube or a microtiter tube.

The device according to the current invention further comprises at least one module adapted to receive and store a sample carrier.

In a preferred embodiment of the invention a module is set up to receive and store a sample carrier used in chemical and/or biological experiments, especially a module used within a device defined herein, wherein the module comprises at least one first module part and at least one second module part, wherein the first module part is set up as a storage unit having an interior space, the interior space being set up to store the sample carrier, wherein the first module part has an opening, wherein the second module part is configured as a transport unit and is set up to be in operative connection with the first module part and a movable actuator system, wherein the transport unit comprises a front side and a rear side located opposite to the front side, wherein the front side is set up to be contacted by a first movable actuator, wherein the second module part is set up to be completely or partially inserted in and/or removed from the first module part through the opening by the movable actuator, wherein the front side has at least a third magnetic means that is set up to be contacted by at least a fourth magnetic means arranged on the first movable actuator for the purpose of transporting the transport unit.

A module according to the current invention is preferably designed in at least two parts. The module is divided into at least a first module part and a second module part, with both module parts being in operative connection. For example, the first module part may be a box with an opening, while the second module part may be a drawer, preferably realized as a transport unit capable of carrying a sample carrier, which is inserted into the first module part, preferably realized as storage unit. A module may also have more than one first module part and more than one second module part. The designation first, second and further module are thereby preferably interchangeably usable.

In one embodiment the rear side of the module comprises at least a first magnetic means that is set up to be contacted by a second magnetic means located on a surface of the interior space of the storage unit opposite to the rear side for the purpose of fixing the second module part within the first module part. This has the advantage that the second module part can be fixed within the first module part. Moreover, the second magnetic means can be activated or deactivated by a controller in case the second magnetic means is an electromagnet.

The module according to the invention is designed to receive at least one sample carrier and to store it. The module can be essentially cuboid in shape and placed by a user in a quadrant, preferably in a first quadrant (e.g. front loader area). Consumables may be stored in another module. Preferably, the footprint of the module and the further module are configured in the same way, so that the module and the further module can be placed in any quadrants. Preferably, a module can be stacked on top of another module or another module, whereby the modules can be placed on top of each other, for example, via a plug-in connection. In an aspect of the current invention, this allows storage units to be stacked on top of each other in the front loader area, while allowing storage of a sample carrier. Therefore, limited space can be used more efficiently, and more samples being stored.

Preferably, the first module part is designed as a storage unit, whereby this has an interior space. This is dimensioned in such a way that the transport unit and the sample carrier can be positioned within the interior space. The storage unit has at least one opening through which the second module part, or the transport unit, can be inserted into the interior space.

Advantageously, this can allow samples to be stored under controlled conditions, such as under a certain temperature, light intensity and/or frequency and gas composition.

In one embodiment the storage unit has at least one opening, wherein a second module part is configured as a transport unit and is in operative connection with a first module part as well as a first movable actuator.

By separating working area modules and front loader area modules, sample manipulation and storage can be performed in parallel and under different conditions, allowing experiments to be performed more efficiently. Furthermore, by using different modules that provide different storage conditions, different experiments can be carried out simultaneously, spatially separated, in a limited space. This is particularly important for experiments that have to be carried out in sterile workbenches.

The device according to the current invention provides means in particular for performing biological experiments or efficacy tests of pharmacologically active substances on two-dimensional cell assemblies and/or three-dimensional cell assemblies. In a preferred embodiment of the invention, the experiments may be automated. Particularly preferred, the experiments include the cultivation of cell cultures, for example for the production of pharmaceuticals.

A two-dimensional cell assembly is understood to be at least one layer (e.g. monolayer) of cells formed within a cavity. It is also possible that the two-dimensional cell association is formed from more than one layer. A three-dimensional cell association is understood to be cells that are arranged within a support matrix. For example, an organoid is a three-dimensional cell assembly. Preferably, the device according to the invention is adapted to generate a two-or three-dimensional cell structure within a cavity.

The device according to the invention has at least one means which is set up to produce two-or three-dimensional cell assemblies. Such a means can be at least one tool, which is arranged at least one movable actuator and is set up for receiving and/or dispensing liquids such as cell suspensions. Preferably, the means is actuated by the controller to deliver a volume of a chemical substance or a biological material into a cavity, or to at least partially empty the cavity. Preferably, the means is actuated by the controller. Further preferably, the means is operated electrically, pneumatically, or hydraulically.

The efficacy test in the context of this invention means a procedure in which a biological material is brought into contact with a chemical substance in order to determine what effect the chemical substance has on the biological material. An efficacy test is further a procedure in which a biological material is brought into contact with another biological material (e.g., pathogens, proteins). In an alternative embodiment of the invention, an efficacy test may be any experiment which determines the effectiveness or efficiency of a particular biological structure or system in achieving its intended purpose, often involving the measurement or analysis of relevant parameters, performance metrics, or desired outcomes, especially if related to the production or testing of pharmaceuticals or biotechnological products.

A pharmacologically active substance is understood to be a chemical substance that has an influence on biological material and affects, for example, the metabolism of cells.

Furthermore, the device comprises means adapted to generate the two-dimensional and/or the three-dimensional cell assemblies within the cavity of the sample carrier. In some embodiments, this can be done using a movable actuator and can comprise using microfluidic systems, cell culture, magnetic manipulation, scaffold-based techniques, and/or bioprinting techniques.

In a preferred embodiment, the means of the device are a combination of various aspects of the invention, such as different modules, storage units, and sample carriers, with the biological material being transported between the components by the movable actuator system and monitored by an automation process.

A storage unit comprised by the device has at least one opening and a second module part, which is configured as a transport unit and is in operative connection with the first module part as well as the first movable actuator.

The second module part is designed as a transport unit. The transport unit is used to hold the sample carrier and is transported from one quadrant to another quadrant by the movable actuator.

In one embodiment of the current invention, the transport unit is set up to be completely or partially inserted and/or removed by the first movable actuator through the opening into the first module part.

In an aspect related to the device, the transport unit is designed to receive the sample carrier and has at least one locking means, which is set up to reversibly fix the sample carrier to the transport unit.

Preferably, the transport unit has at least one locking means. The locking means serves to reversibly fix the sample carrier to the transport unit. Advantageously, it can thus be achieved that the sample carrier cannot slip within the interior of the storage unit. The locking means can be designed, for example, as a clamp which presses the sample carrier against an area of the transport unit. Other elements can also be considered as locking means. For example, the surface of the transport unit on which the sample carrier is placed can have at least one element which provides increased static friction of the sample carrier relative to the transport unit. For example, the element can be formed from a silicone or a rubber. Advantageously, this means that the sample carrier does not have to be placed between a locking means, for example in the form of a clamp, but it is sufficient to place the sample carrier on the transport unit.

In one embodiment the transport unit is designed to receive the sample carrier and has at least one locking means, which is set up to reversibly fix the sample carrier to the transport unit.

In a preferred embodiment the invention comprises an automated device for performing chemical and/or biological experiments, wherein the device comprises at least two areas, said areas being configured as at least one working area and at least one front loader area, each of said areas being divided into at least one quadrant, wherein the device comprises a movable actuator system which is attached to a trolly connected to a kinematic system, wherein a first movable actuator is being adapted to transport a sample carrier comprising at least one cavity from a first quadrant into a second quadrant or a further quadrant, wherein the device comprises at least one module adapted to receive and store the sample carrier, wherein a second movable actuator is adapted to fill the cavity with a volume of a chemical substance and/or a volume of a biological material and/or to remove at least partially the volume from the cavity when the sample carrier is positioned in the first quadrant or in the second quadrant or in the further quadrant, wherein the module is at least realized in a two part structure and has at least one first module part and at least one second module part, the first module part being designed as a storage unit and having an interior space, the interior space being set up to store the sample carrier and wherein the second module part is in operative connection with the first module part and/or the movable actuator system.

According to one embodiment the automated device provides means in particular for performing biological experiments or efficacy tests of pharmacologically active substances on two-dimensional cell assemblies and/or three-dimensional cell assemblies.

According to one embodiment the device comprises means adapted to generate the two-dimensional and/or the three-dimensional cell assemblies within the cavity of the sample carrier.

In a preferred embodiment the invention relates to an automated device for performing chemical and/or biological experiments, wherein the device comprises at least two areas, said areas being configured as at least one working area and at least one front loader area, each of said areas being divided into at least one quadrant, wherein the device comprises a first movable actuator that is set up to transport a sample carrier or a transport unit from a first quadrant into a second quadrant or a further quadrant, wherein the device comprises at least one module that is set up to receive and store the sample carrier, wherein the module is at least realized in a two-part structure and has at least one first module part and at least one second module part, wherein the first module part is set up to accommodate the second module part, wherein the second module part is set up for an operative connection with the first module part and/or the first movable actuator, wherein a third magnetic means is located at a side of the second module part, preferably at a front side of the second module part, and a fourth magnetic means is located at the first movable actuator, wherein the third magnetic means is set up to be contacted by the fourth magnetic means for the purpose of transporting the second module part between the quadrants.

The first movable actuator is preferably mounted to a movable actuator system.

In a preferred embodiment of the invention relates to an automated device for performing chemical and/or biological experiments, wherein the device comprises a base surface, wherein the device comprises at least two areas, said areas being configured as at least one working area and at least one front loader area, each of said areas being divided into at least one quadrant, wherein the device comprises a first movable actuator that is set up to transport a sample carrier or a transport unit from a first quadrant into a second quadrant or a further quadrant, wherein the device comprises at least one module that is set up to receive and store the sample carrier, wherein the module is at least realized in a two-part structure and has at least one first module part and at least one second module part, wherein the first module part is set up to accommodate the second module part, wherein the second module part is set up for an operative connection with the first module part and/or the first movable actuator, wherein a magnetic means is located at the first movable actuator and/or at the base surface, wherein the magnetic means is set up to transport the second module part and/or the sample carrier from one quadrant to another quadrant or to fix the second module part or the sample carrier to the base surface.

In one embodiment the magnetic means comprises a fourth magnetic means that is located at the first movable actuator, wherein a third magnetic means is located at a side of the second module part, preferably at a front side of the second module part, wherein the third magnetic means is set up to be contacted by the fourth magnetic means for the purpose of transporting the second module part between the quadrants.

In a preferred embodiment of the invention the automated device for performing chemical and/or biological experiments, wherein the device has a base surface, wherein the device comprises a movable actuator system, wherein the device comprises a first movable actuator that is set up to transport a sample carrier or a transport unit (from a first quadrant into a second quadrant or a further quadrant, wherein the base surface or at least one quadrant comprises at least one magnetic positioning means, wherein the magnetic positioning means is arranged below the base surface or is part of the base surface, wherein the magnetic positioning means is set up to reversibly fix a transport unit or a sample carrier to the base surface.

Fixing is understood to be an operation in which a module, another module, a transport unit or a container is positioned within a quadrant in such a way that it remains in this position when used as intended and, in particular, cannot slip, for example due to vibrations. In an alternative embodiment of the present invention, reversibly fixing an object means restricting its movement in at least one, preferably two, alternatively three spatial axes x, y, z for a certain period of time. This can be in the form of placing the object adjacent and/or on a locking means, preferably a magnetic means.

In one embodiment the fourth magnetic means is an electromagnet which is set up to be activated by a controller comprised by the device for the purpose of transporting the transport unit between at least two quadrants and, as soon as the transport unit is positioned within a quadrant, is deactivated again by the controller.

The advantage of using an electromagnet is that it can be easily activated or deactivated by an electrical circuit or a controller.

Preferably, the device comprises at least one quadrant comprising a magnetic positioning means, wherein the magnetic positioning means is arranged below or is part of the base surface of the device. The magnetic positioning means is preferably arranged within a quadrant. The magnetic positioning means can be designed as a permanent magnet or electromagnet. Preferably, the magnetic positioning means is designed as an electromagnet. This can be activated via the controller. The magnetic positioning means is preferably in active connection with the movable actuator. For example, the movable actuator can transport the transport unit to the quadrant and position it there, with the controller then activating the magnetic positioning means in order to fix the transport unit within the quadrant by the magnetic positioning means fixing the transport unit in operative connection with an opposing positioning means arranged below the transport unit, i.e. on its underside. By means of the magnetic positioning means, it can be advantageously achieved that a frame which positively fixes the module, further module or container to be positioned within the quadrant can be easily and reversibly removed. Thus, the base surface has no elevations, is easier to clean and the risk of contamination is reduced.

According to one embodiment at least one quadrant comprises a magnetic positioning means, wherein the magnetic positioning means is arranged below or is part of the base surface of the device

According to one embodiment on an underside of the transport unit and/or on an underside of the module and/or on the underside of a module carrier encompassed by the device at least one opposing positioning means is arranged which, in operative connection with the magnetic positioning means of the quadrant, is set up to align and fix the transport unit and/or the module and/or the module carrier within the quadrant.

The base surface refers to the surface of the device that is the top surface of the base. The surface preferably has a magnetic or magnetizable material, preferably a magnetic metal. The base surface is arranged such that a frame can be magnetically fixed thereon and is divided into at least one quadrant or at least one area by this.

The base designates the part of the device that terminates at its upper boundary with the base surface. The base includes, for example, the control and/or data transmission means and other means such as pumps.

Furthermore, in an aspect of the invention in which an underside of the transport unit and/or on an underside of the module and/or on the underside of a module carrier are encompassed by the device at least one opposing positioning means is arranged which, in operative connection with the magnetic positioning means of the quadrant, is set up to align and fix the transport unit and/or the module and/or the module carrier within the quadrant.

In one embodiment on an underside of the transport unit and/or on an underside of the sample carrier and/or on an underside of a module at least one opposing positioning means is arranged which, in operative connection with the magnetic positioning means, is set up to align and fix the transport unit and/or the sample carrier and/or a module within the quadrant.

The module carrier is adapted to receive and arrange at least one module, another module or a container with respect to the base plate. The module carrier can be a frame-shaped construction or a substantially plate-shaped construction that is mounted on or inserted into the frame that is fixed on the base surface. At least one module, another module or a container can then be arranged on the module carrier. There may also be multiple module carriers. For example, the module carriers may differ in shape and dimensions. A module carrier can also be designed in such a way that it can be connected to another module carrier, in particular plugged onto the other module carrier. In this way, it can be advantageously achieved that the position of a module, of a further module or of a container can be varied in a height, relative to the base surface. For example, to change the height of a module, two or more module carriers could be placed on top of each other. A module carrier can have at least one magnetic positioning means.

The transport unit, module, further module, module carrier or container has an underside. The underside is the side which is closest to the base surface in intended use. The underside can have at least one opposing positioning means, this being set up to fix the module, the further module, the module carrier or the container within a quadrant in operative connection with the magnetic positioning means.

The device preferably provides a frame, wherein at least one quadrant is at least partially framed by the frame, wherein the frame is raised with respect to the base surface of the device, wherein the frame underside is equipped with magnetic positioning means able to fix the frame to the base surface, and wherein the frame and/or the module and/or the module carrier is adapted to be placed on at least one raised positioning means, wherein the raised positioning means is connected to the base surface and is configured in particular as a pin.

A frame can be provided, which is set up to positively limit a module, a further module, a transport unit or a container in at least two degrees of freedom within the X-Y plane, i.e. the plane that is parallel to the base surface, and thus to fix it in the X-Y plane. Preferably, the framing is raised relative to the base surface. The module, further module, transport unit or container to be placed inside the framing can be inserted into the framing from above (in the Z-axis). Preferably, the framing has at least one fastening means which, in operative connection with a raised positioning means, serves to fix the framing in the X-Y plane on the base surface. Preferably, the framing is placed on a raised positioning means. Particularly preferably, the framing sets up magnetic positioning means on the underside, by means of which it can be fixed to a magnetic base plate. Alternatively, the framing may have an opposing positioning means on its underside, which is set up in operative connection with the magnetic positioning means of at least one quadrant for fixing the framing. The framing can be removed again from the raised positioning means. Advantageously, it can thus be achieved that the framing as well as the base surface below the framing can be easily cleaned.

According to one embodiment the device comprises a frame, wherein at least one quadrant is at least partially framed by the frame, wherein the frame is raised with respect to the base surface of the device, wherein the frame underside is equipped with magnetic positioning means able to fix the frame to the base surface, and wherein the frame and/or the module and/or the module carrier is adapted to be placed on at least one raised positioning means, wherein the raised positioning means is connected to the base surface and is configured in particular as a pin.

A raised positioning means is arranged so that a frame can be placed on it. For example, the raised positioning means is designed as a pin. In the event that the frame is to be placed on the pin, the frame has holes in which the pins are guided so that the degrees of freedom of the frame in the X-Y plane are restricted. Pins are elevated structures with enough structural integrity to fix the attached object against movement in the X-Y plane.

The frame underside is the side which is closest to the base surface in intended use. The frame underside can have at least one opposing positioning means.

The second module part or the transport unit has at least one side. The second module part or the transport unit is preferably rectangular in shape, but can also have other shapes, such as a circle.

In one preferred embodiment of the invention, a transport unit comprises a front side and a rear side, the front side being adapted to be contacted by the first movable actuator for the purpose of transporting the transport unit, the rear side being arranged opposite the front side, said rear side comprising at least a first magnetic means adapted to contact a second magnetic means located on a surface of the interior space of the storage unit opposite to said rear side.

The front side designates the part of the transport unit that is closest to the movable actuator during transport of the transport unit by the movable actuator. The front side is arranged opposite the rear side. The front side is adapted to be contacted by the movable actuator. The front side may include at least a fourth magnetic means and/or a retaining element. The holding element (e.g., a handle) is adapted to allow a user to remove the transport unit from the first module part without requiring the movable actuator.

The rear side designates the part of the transport unit which is furthest away from the movable actuator during transport of the transport unit by the movable actuator. The rear side is arranged opposite the front side.

A first magnetic means may be formed of a permanent magnet or a metal which is attracted by a magnet. Preferably, the first magnetic means is arranged at the rear of the transport unit. The first magnetic means is in operative connection with the second magnetic means. The second magnetic means may also be formed of a permanent magnet or a metal that is attracted to a magnet. Preferably, the second magnetic means is arranged on a surface of the interior which is arranged opposite the rear side. Advantageously, the module can be transported without the transport unit falling out. Of course, the force of the magnet of the movable actuator must be greater than the force of the magnet that fixes the transport unit inside the first module.

In an especially preferred embodiment, wherein the transport unit comprises a front side and a rear side, the front side being adapted to be contacted by the first movable actuator for the purpose of transporting the transport unit, the rear side being arranged opposite the front side, the front side comprising at least a third magnetic means adapted to be contacted by at least a fourth magnetic means, the fourth magnetic means being arranged on the first movable actuator.

A third magnetic means may be formed of a permanent magnet or a metal and is preferably arranged at the front of a transport unit. Preferably, the third magnetic means is formed of a metal which is attracted by a magnet. Preferably, the fourth magnetic means is formed of an electromagnet which is arranged on the movable actuator. Preferably, the fourth magnetic means is actuated and activated or deactivated by the controller. In active connection with the third magnetic means, the fourth magnetic means is set up in the activated state to transport the transport unit.

In one embodiment of the invention, the device related to the fourth magnetic means is an electromagnet which is arranged to be activated for the purpose of transporting the transport unit by a controller comprised by the device and, as soon as the transport unit is positioned within the first quadrant, second quadrant or further quadrant, to be deactivated again by the controller.

According to one embodiment the fourth magnetic means is an electromagnet which is arranged to be activated for the purpose of transporting the transport unit by a controller comprised by the device and, as soon as the transport unit is positioned within the first quadrant, second quadrant or further quadrant, to be deactivated again by the controller

Among other things, the controller serves to activate or deactivate electromagnets. Furthermore, the controller serves the movement of the movable means as well as the control of the means, which are arranged for a reception and/or delivery of liquids such as cell suspensions. Preferably, the controller is able to detect in which quadrants which objects are present. These objects may be modules, further modules, transport units or containers. Preferably, the controller is set up to plan or organize the course of the experiment depending on the position of the objects. The planning can take place fully automatically, so that no user is necessary who monitors the correct deposition of the modules. It is preferred that the controller handles the movable actuator, in particular the means used to aspirate fluids, in such a way as to prevent aspiration of a cell assembly such as an organoid. Preferably, the control may be accessed by a computer program, algorithm, machine intelligence or artificial intelligence. The terms control and controller in the context of the current invention are used interchangeably. A controller may be a microchip, a computer or and integrated circuit.

An electromagnet is a magnet that is preferably activated by the controller to attract a metal element (e.g. the third magnetic means or the opposing positioning means) in the magnetized state. The controller can also deactivate the electromagnet again. The activation of an electromagnet refers to the process of energizing the electromagnet to generate a magnetic field. The activation of an electromagnet can be realized by a controller, which connects and/or activates an electrical power source with the electromagnet.

Preferably, the device is featuring an opening and/or an edge facing the opening, which is arranged at the front side of the transport unit, is provided with a sealing element adapted to reduce the risk of contamination of the interior space of the storage unit and/or to reduce or prevent gas exchange between the interior space and the space outside the storage unit.

According to one embodiment the opening and/or an edge facing the opening, which is arranged at the front side of the transport unit, is provided with a sealing element adapted to reduce the risk of contamination of the interior space of the storage unit and/or to reduce or prevent gas exchange between the interior space and the space outside the storage unit.

An edge is defined as the point of the transport unit which, when used as intended, bounds the front side in the X-Z or X-Y plane. Preferably the opening of the first module part and/or the edge has a sealing element.

In one embodiment of the module a sealing element is positioned along the opening, whereby the sealing element is set up to reduce the risk of contamination of the interior space and/or to reduce or prevent gas exchange between the interior space and the space outside the storage unit.

The sealing element is designed to seal off the interior from the space outside the storage unit. In this way, it can be advantageously achieved that contamination of the interior space is avoided. For example, the sealing element is formed from a rubber or silicone lip or a similar means. Further preferably, the sealing means is adapted to seal the gas exchange between the interior space and the space surrounding the storage unit. Advantageously, this means that cell cultures, for example, which require a defined gas composition for development, are not exposed to excessive fluctuations in the gas concentration. This applies in particular if the storage unit also has a fumigant.

A gas exchange is the process by which there is a change in concentration of a gas within one volume relative to a second volume.

In some embodiments, the dimensions of the device in accordance with the current invention are such that the entire device can be placed within a sterile work area of a sterile workbench.

In a preferred embodiment, the dimensions of the device are selected such that the entire device can be placed in a sterile working area of a sterile workbench.

In a preferred embodiment, the device according to the invention is further housed in an enclosure made of lightweight materials such as wood, aluminum sheet, or plastic that allows the laminar flow of a sterile worktable to be unimpeded. An enclosure may be any structure surrounding the device that is not necessary for structural integrity of the device and serves to cover portions of the device, preferably without obstructing any functions.

According to one embodiment the dimensions of the device are such that the entire device can be placed within a sterile work area of a sterile workbench.

A sterile workbench, also referred to as a safety workbench, is a sterile workbench used in cell culture laboratories or when working with sensitive materials, such as semiconductor materials in semiconductor technology. A safety workbench consists of a work table with a housing that is specially ventilated. The sterile workbench typically utilizes a high-efficiency particulate air (HEPA) filter system to create a laminar flow of filtered air. The sterile workbench has a sterile work area, by which is meant the area on which is handled with biological material in particular.

In a preferred embodiment of the current invention, the dimensions and shape of the device allow the unhindered laminar flow needed to ensure a sterile environment for biological and/or chemical experiments. More preferred the device in combination with a safety workbench may meet or exceed relevant industry standards and regulations, such as ISO 14644 cleanroom standards or specific biological safety regulations.

In an alternative embodiment of the invention, the working area and the modules in the working area are biologically sealed and meet the safety regulations for person and product protection as specified in DIN EN 12469 (Class II).

Preferably the device provides at least a module that can be connected to the base surface of the device and/or at least one further module, in particular via an electrically communicating connection, wherein the electrically communicating connection is set up for the transmission of data and/or electrical energy.

An electrically communicating connection is set up for the exchange of data and/or the transmission of control signals from or to the controller. The electrically communicating connection does not have to be realized by a plug connection. It can also be realized by a magnetic connection, whereby the electrically communicating connection is established by the correct positioning of the module on the quadrant, for example brought about by the operative connection of the magnetic positioning means with the opposing positioning means on the underside of the module. Advantageously, a magnetic connection means that there are no slots which would have to be cleaned at great expense. In a preferred embodiment, the electrically communicating connection may be raised or lowered and the opposite communicating connection may be recessed or raised. When the electrically communicating connection is elevated on a top surface or surface, this has the technical effect of reducing the risk of an electrical fault if liquids are spilled.

In one embodiment of the device the electrically communicating connection is designed as a bus connection, wherein the bus connection is set up for the exchange of data between at least two modules among each other and/or between the module and the controller and/or for the exchange of data and/or electrical energy between the module, a frame, and a controller within the base comprised by the device, wherein a human machine interface is preferably provided by the base.

A bus is a system for data transmission and/or electrical power transmission between several nodes via a common transmission path. According to the invention, a parallel or serial bus is possible. The simultaneous existence of a parallel and serial bus is equally possible. Preferably, the bus according to the current invention is incorporated into the frame and is connected by electrically communicating connection with modules. This has the advantage to eliminate the need of open cables, which reduces risk of accidents or damages caused by accidental spilling of liquids.

It can be provided that a module has at least one electrical load (e.g. a lamp or LED). Consequently, the module requires electrical energy, which is provided, for example, via the electrically communicating connection.

The human machine interface refers to the technology or interface through which humans interact and communicate with the device according to the current invention. The human machine interface may provide interaction means such as a graphical user interface (GUI), a touchscreen, a voice assistant and/or voice recognition, physical controls, for example physical buttons, switches, knobs, sliders, or dials.

Preferably the device, in particular the movable actuator system, comprises at least one optical sensor, wherein the optical sensor is set up to monitor a filling and/or an emptying of the cavity and/or the transport of the transport unit and/or the course of the experiment, and/or wherein the optical sensor is set up to determine a filling quantity of consumables and/or their position within the device and/or the type of consumables, and/or wherein the optical sensor is set up to determine a temperature, in particular a temperature within the cavity.

An optical sensor uses waves of the electromagnetic spectrum to determine measured variables. For example, an optical sensor can be an infrared thermometer (pyrometer). An optical sensor can also be designed as a camera. The optical sensor is set up to provide the controller or another computing unit with measured variables that provide information about the course of the experiment. For example, an optical sensor can be set up in combination with an algorithm and/or a machine and/or artificial intelligence to determine the position of modules, further modules, transport units, or containers that are arranged on the base surface within quadrants. Furthermore, an optical sensor may also be arranged to identify a sample carrier. Preferably, the optical sensor is able to determine the type of consumables, for example, the manufacturer and the shape. The detection of consumables by an optical sensor advantageously enables better planning of experiments. One could imagine that when the number of pipette tips is too low, a message is delivered to a smartphone of an employee, whereupon the employee refills the consumables so that the course of the experiment is not interrupted. Furthermore, the device may have a further sensor. This further sensor is used to detect process parameters, filling levels of cavities or containers, filling quantities of consumables, temperatures, humidity or electrical fields. The presence of at least one additional sensor advantageously allows the determination of various process parameters, which in their combination have an influence on the course of the experiment. These process parameters can be determined by at least one further sensor.

Consumables are means which are necessary to perform the experiments, in particular to fill the wells with a chemical substance or a biological material. For example, a consumable may be pipette tips or hydrogels. Further included are, for example, suspensions or nutrient media. It may also be provided that a consumable material, particularly if it is a liquid, is temperature controlled.

A further module can serve as a storage unit for consumables. The filling quantity of the consumable material can be determined via an optical or a further sensor. The consumable material can be positioned at preferably any quadrant, whereupon the controller detects at which position the consumable material is stored. Advantageously, the user is thus not limited to depositing the consumable in exactly one place. Instead, he can, for example, place several tip boxes in stock on the base surface.

Positioning is understood to be an operation in which a module, a further module, a transport unit or a container is placed within a quadrant. Preferably, the placed module, the placed further module, the transport unit or the placed container is positioned within the quadrant in such a way that it cannot slip during intended use.

Temperature means a physical quantity that measures the degree of hotness or coldness of an object or environment and represents the average kinetic energy of the particles within a substance and/or material. It may be measured with a thermal sensor being in contact with the substance or material or with remote measuring technology like infrared thermometry.

In a preferred embodiment the optical sensor is set up to determine the position of a two-dimensional and/or three-dimensional cell structure, in particular a spheroid and/or an organoid, within the cavity, wherein the controller controls the second movable actuator as a function of the position determined by the optical sensor.

An organoid refers to an organ-like microstructure a few millimeters in size that can be artificially generated using cell culture methods. Under suitable culture conditions, organoids can be grown from one or a few tissue cells, embryonic stem cells or induced pluripotent stem cells.

A spheroid refers to aggregates of cells that grow in a spherical shape, mimicking the behavior and organization of cells in a tissue or organ.

Preferably the device or the module comprises a data transfer means, the data transfer means being adapted to exchange data with an external computer, a cloud, or a mobile device.

The term cloud is the abbreviation of cloud computing. In general, one speaks of “storing something in the cloud”. As a rule, this means storing data on a remote server. The transfer from the user's end device (PC, tablet, smartphone) takes place via the Internet. Once the files have been stored in a cloud, they can be retrieved later using any other device. The advantage of using a cloud is a reduced need for storage on the local devices/device and that no dedicated server is required (minimized effort for hardware and IT staff).

Data or data sets are defined herein as any information that can be processed by a technical device, in particular a computer or processor.

An external computer is at least one technical device comprising at least one processor, which is not identical in location to the device according to the invention.

A mobile device is any technical device that can be conveniently transported by a user. For example, a smartphone or tablet is a mobile device.

Furthermore, the device or the module comprises a crosslinking agent which is adapted to crosslink chemical substances, in particular proteins, present in the cavity with one another.

A crosslinking agent (also: crosslinking module or crosslinking means) is designed to crosslink chemical substances with each other. A crosslinking agent is, for example, a UV lamp, which can be arranged within a module. The crosslinking agent can be controlled via the controller.

In one embodiment the module comprises a crosslinking means which is adapted to crosslink chemical substances, in particular proteins, present in a cavity of the sample carrier with one another.

A vibrating surface is set up to generate vibrations. Preferably, the vibrating surface is controlled by the controller. The advantage of using a vibrating surface is that the contents of the cavity can be mixed by the movable actuator, for example, for the duration of the filling process. Preferably, the vibrating surface is controlled by the controller. Further preferably, the vibrating surface has a magnetic positioning means so that objects placed on the vibrating plate, such as sample carriers, can be fixed to the vibrating plate at least for the duration of the vibration. It is also advantageous that a container placed on the vibrating surface can be continuously shaken so that the contained liquid remains mixed. This prevents, for example, cell populations from settling within the liquid or suspension during the time the cavities are filled.

In one embodiment at least one quadrant of the base surface comprises a vibrating surface, wherein the vibrating surface is adapted to cause the transport unit or the sample carrier to vibrate. The vibrating surface has the advantage that a sample carrier, especially a volume of a substance inside a cavity can be shaken so that, for example, particles remain mixed within suspensions.

The vibrating surface can be activated or deactivated by a controller. In another embodiment, the module, especially the first module part or the second module part comprises a vibrating surface. This has the advantage that even when a sample carrier is stowed within a module, the sample carrier can be shaken.

In one embodiment the vibration surface comprises a magnetic positioning means that is set up to reversibly fix the transport unit or the sample carrier to the vibrating surface. This has the advantage that the transport unit or the sample carrier is fixed to the vibrating surface during shaking. The magnetic positioning means is preferably set up to be driven by a controller. The magnetic positioning means comprised by the vibrating surface is preferably an electromagnet.

A magnetic positioning means can be used for fixing a transport unit and/or a second module part and/or a module to the base surface and/or the vibrating surface. Using a magnetic positioning means for fixing a transport unit or a sample carrier to the vibration surface of the base surface has the advantage that pins for fixing can be omitted to have an even surface.

Proteins refers to a biological material consisting of complex organic macromolecules that are composed of chains of smaller units called amino acids, also referred to as peptides, which are linked together through peptide bonds.

In a preferred embodiment at least one quadrant comprises a vibrating surface, wherein the vibrating surface is adapted to cause the sample carrier to vibrate.

Preferably, the vibrating surface is connected to the base surface via a flexible plastic. Advantageously, there is no gap between the vibrating surface and the base surface. This makes it easier to clean the surface and reduces the risk of contamination.

Preferably, at least one vibrating surface can be provided by the device, which comprises at least one magnetic positioning means, which is adapted to fix the transport unit to the vibrating surface via the opposing positioning means arranged on the transport unit and/or containers.

According to one embodiment the vibrating surface comprises at least one magnetic positioning means, which is adapted to fix the transport unit to the vibrating surface via the opposing positioning means arranged on the transport unit and/or containers.

A container can contain any liquid or suspension. The container is arranged to be received in a transport unit. The bottom of the container may have an opposing positioning means to fix the container a of a transport unit.

In a preferred embodiment, the perimeter of the vibrating surface is connected to the base surface via a flexible plastic.

The flexible plastic may be formed from any material, preferably a material that is easy to clean. Further preferably, the flexible plastic is formed from a silicone.

Further preferred is a device according to the current invention, which comprises at least one further sensor and/or at least one actor, in addition to the optical sensor, wherein the further sensor is used to detect process parameters and/or at least one actor influences process parameters, in particular a filling level of the cavity and/or the filling quantity of the consumables, furthermore physical process parameters such as the temperature and/or an oxygen (O₂) content in the samples and/or an air humidity, and/or the light intensity, in particular the light intensity in the UV range, and/or a pressure of the environment or sample and/or an electric field or for determining the process times of the individual process steps and/or total process times.

The air humidity and/or light intensity and/or pressure of the environment and/or electric field strength and/or oxygen content can be determined by a further sensor or further sensors. Preferably, the device according to the invention has technical means which are set up to set a specific air humidity and/or light intensity and/or pressure of the environment and/or electric field strength and/or oxygen content within an area of the device, for example in the interior of the storage unit and/or a further module. This can be accomplished by at least one actor, for example a lamp, an UV lamp, an infrared heater or electrical heating element, a cooling element. An actor refers to an element that can influence the physical properties of an environment in which it is found, for example, by emitting electromagnetic radiation at different wavelengths.

A process parameter comprises all variables that can be determined by the optical sensor or by other sensors. By determining and processing, in particular storing, process parameters, the device is enabled to increase the reproducibility of experiments. This is achieved, for example, by a computer program product, in particular an algorithm, a machine or artificial intelligence, accessing stored process parameters and controlling technical means of the device that are set up to produce the same physical conditions (e.g. temperature, humidity) for the duration of the experiment.

The device can provide at least one quadrant comprising a thermal surface, said thermal surface being adapted to be activated or deactivated by the controller and being adapted to maintain, decrease or increase the temperature of the sample carrier and thus the temperature of the contents of the cavity and/or the temperature of a reagent.

According to one embodiment at least one quadrant comprises a thermal surface, said thermal surface being adapted to be activated or deactivated by the controller and being adapted to maintain, decrease or increase the temperature of the sample carrier and thus the temperature of the contents of the cavity and/or the temperature of a reagent.

As used herein, a reagent is any liquid or suspension that is introduced into a cavity at any time. A reagent can be stored in a container. A reagent may be, for example, a chemical substance or a cell suspension.

A thermal surface is designed to cause thermal energy to be introduced into or extracted from an object placed on it, such as a sample carrier. For this purpose, the thermal surface can have at least one Peltier element or another means that is adapted to rise or lower a temperature. Advantageously, it can thus be achieved that the contents of the cavity as well as the liquid or a reagent to be conveyed into it have a certain temperature. Furthermore, the thermal surface can have a magnetic positioning means, for example to fix a sample carrier or a container on the thermal surface. The thermal surface can be equipped with at least one further sensor, in particular a temperature sensor. The thermal power emitted or the thermal energy extracted is preferably influenced by the controller, which determines this on the basis of the variables determined by the optical or further sensor.

In a preferred embodiment, the interior space of the storage unit is adapted to set an incubation temperature which is unequal or equal to the amount of the temperature outside the storage unit.

According to one embodiment the activity of the thermal surface, in particular the reduction or increase of the temperature inside the cavity, is dependent on the temperature determined by the optical sensor or the further sensor.

As used herein, an incubation temperature is the temperature that prevails in the interior of a storage unit. Certain incubation temperature are needed for specific experiments, especially for cell culture cultivation. Therefore, controlling the incubation temperature allows for optimized condition for such biological experiments.

In one embodiment the first module part is set up to adjust a temperature within the interior space of the storage unit, whereby the temperature is unequal or equal to the temperature outside the storage unit. This has the advantage of using the storage unit as an incubator which means that a sample carrier to be incubated or tempered does not have to be stored outside the module.

Preferably, the activity of the thermal surface, in particular the reduction or increase of the temperature inside the cavity, is dependent on the temperature determined by the optical sensor or the further sensor.

More preferably, the temperature can be monitored by distance temperature measurement. It may be measured with remote measuring technology like infrared thermometry. This advantageously allows for temperature control without interacting directly with the contents of a cavity, thus reducing the risk of contamination or negatively influencing the course of an experiment.

Some embodiments of the device comprise a fumigant adapted to modify a gas composition within the interior space. A fumigant is set up to modify the gas composition within a volume, in particular in the interior of the storage unit. Advantageously, it can be achieved in this way that a specific gas composition can be produced, which is optimal for cell cultures stored in the interior, for example.

According to one embodiment the device comprises a fumigant adapted to modify a gas composition within the interior space.

In one embodiment the module comprises a fumigant that is set up to modify a gas composition within the interior space.

A gas composition may correspond to, or differ from, the ambient air surrounding the device.

An opposing positioning means is set up to effect a fixing of a module, a further module, a transport unit or a container within a quadrant in operative connection with a magnetic positioning means. Preferably, at least one magnetic positioning means is arranged on the underside of a module, a further module, a transport unit or a container. The opposing positioning means may be, for example, a magnet or a metal strip, wherein the metal strip comprises a metal that is attracted to a magnet. The opposing positioning means may be further configured to align the orientation of the module, further module, transport unit or container to be fixed. For example, three opposing positioning means could be arranged on the underside of a module, further module, transport unit or container in such a way that the opposing positioning means each form the apex of a triangle. In or below the base surface or quadrant, at least three magnetic positioning means may also be arranged in a triangle so that the module, further module, transport unit or container is fixed within the quadrant only when the triangles are aligned congruently. Shapes other than a triangle may also be considered.

In a preferred embodiment the storage unit and/or the transportation unit is transparent in whole or in part. A module can have a transparent means at least in sections and be transparent in this section. The skilled person can freely determine the opacity of the transparent means (e.g. glass). Advantageously, a transparent means allows that a user is able to observe, for example, the sample carrier, in particular the cavities without having to open the storage container.

According to one embodiment the storage unit and/or the transportation unit is transparent in whole or in part.

The invention also provides a computer program product comprising instructions which cause a computer to enable the exchange of data between the device and a knowledge database, wherein the knowledge database is set up to store a sequence of the experiment, in particular of process parameters detected during the experiment by an optical sensor and/or a further sensor, wherein the computer program product stores the detected parameters as data in the knowledge database and makes them available on demand.

According to one embodiment the invention comprises a computer program product with instructions that cause a computer to enable the exchange of data between the device and/or module and a knowledge database, wherein the knowledge database is set up to store a sequence of the experiment, in particular of process parameters detected during the experiment by an optical sensor and/or a further sensor, wherein the computer program product stores the detected parameters as data in the knowledge database and makes them available on demand.

A computer or calculator is a technical device that processes data by means of programmable calculation rules.

The sequence of the experiment describes the entirety of the processes from loading the wells with chemical substances and/or biological materials to removing the sample carriers from the device.

A retrieval of data is understood to be a download of data, in particular a download of data from the knowledge base.

Preferably, the device according to the invention comprises a knowledge database in which, for example, external protocols can be stored. Preferably, several devices according to the invention can access the knowledge database independently of each other. In this respect, the devices/devices are networked via the knowledge database.

The invention also provides a computer system which is arranged to have an algorithm, a machine or an artificial intelligence executed thereon, wherein the algorithm, or the machine or the artificial intelligence is arranged to plan or monitor an experiment carried out by means of the device, logging its execution and optimizing it depending on required process flows, wherein the algorithm, or the machine or artificial intelligence is arranged to access the knowledge database in order to retrieve data therefrom or to store data thereon.

According to one embodiment the invention comprises a computer system that is arranged to have an algorithm, a machine or an artificial intelligence executed thereon, wherein the algorithm, or the machine or the artificial intelligence is arranged to plan or monitor an experiment carried out by means of the device, logging its execution and optimizing it depending on required process flows, wherein the algorithm, or the machine or artificial intelligence is arranged to access a knowledge database in order to retrieve data therefrom or to store data thereon.

An algorithm is a unique set of instructions for solving a problem or a class of problems. Algorithms consist of a finite number of well-defined individual steps. The algorithm according to the invention is advantageously implemented in a computer program for execution. The computer program product according to the invention, in particular an algorithm may also have a calendaring function to schedule sequences of experiments. A scheduling program may be provided to terminate experiments.

Required process flows refer to procedures that are necessary to successfully conduct an experiment.

Preferably, the computer system provides means wherein the algorithm or machine or artificial intelligence is adapted to generate protocols from scientific publications or other data sets and to store them in the knowledge database.

According to one embodiment the algorithm or machine or artificial intelligence is adapted to generate protocols from scientific publications or other data sets and to store them in a knowledge database.

In this document, a protocol is understood to be a set of instructions for carrying out an experiment. Scientific publications contain protocols that are essential for conducting experiments. Preferably, the device according to the invention is set up to extract data from scientific publications and to use these data as a basis for planning and running experiments. Preferably, this is done automatically. However, it may also be provided that the computer program product according to the invention interacts with a user in order to plan the course of an experiment. Automated generation of protocols may enable a more efficient planning and automation of a development process. In addition, the means according to the invention can be used to find correlations that are not apparent even to the person skilled in the art and to release new and useful protocols.

The invention also provides a data carrier signal which is arranged to transmit data generated by the device to a computer, a cloud, or to a mobile device or to a computer system or to transmit data from a computer a cloud, or a mobile device, or a computer system to the device, in particular to the controller.

According to one embodiment the data carrier signal is arranged to transmit data generated by a device to a computer, a cloud, or to a mobile device, or to a computer system, or to transmit data from a computer, a cloud, or a mobile device, or a computer system to the device, in particular to the controller.

Preferably, the device has at least one data transmission means that is set up to communicate data from one technical unit to another technical unit. The data can be transmitted by cable or by wireless transmission. This has the advantage that any errors or damage occurring during an experiment can be monitored from afar, thus increasing reaction times and reducing unnecessary down times and allowing for quicker problem solving. Preferably, the data carrier signal may be used to transfer experimental data.

### EXAMPLES

An example of an embodiment and further advantages of the invention are shown and explained in more detail below in connection with the following figures, purely schematically, without limiting the invention to them.

Herein shows

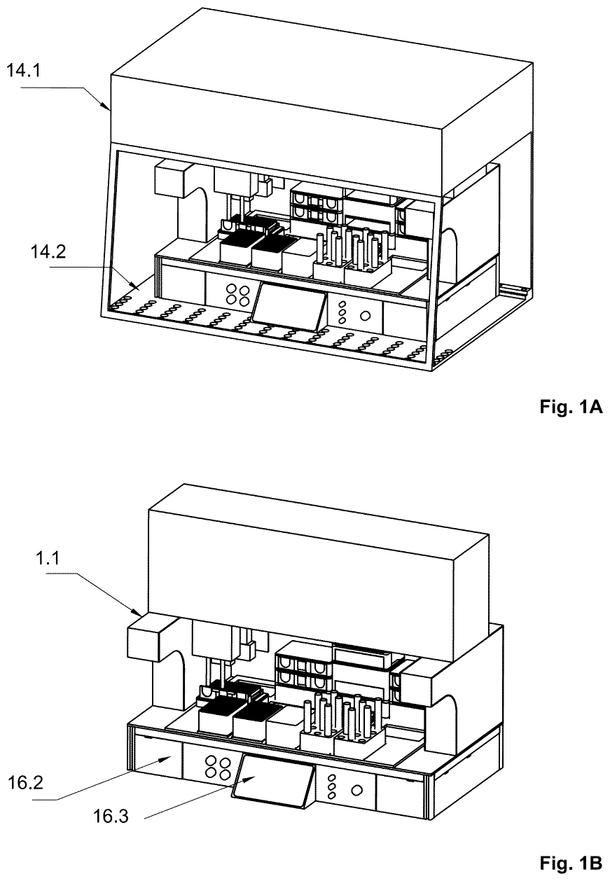

FIG. 1A: Overview of the automated device (1.1) according to the current invention, placed inside the sterile work area (14.2) of a sterile workbench (14.1).

FIG. 1B: Overview of the automated device (1.1) according to the current invention, showing the base (16.2) and human machine interface (16.3).

FIG. 1C: Overview of the automated device (1.1) according to the current invention without enclosure.

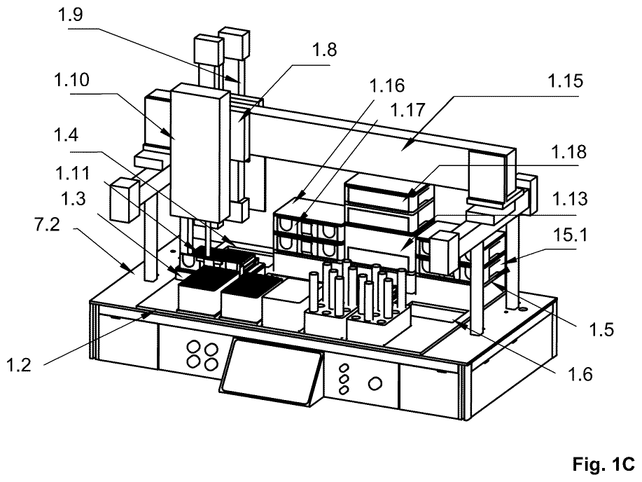

FIG. 2: a) A module (1.13) of the device according to the current invention. Left: view from diagonally above, right: view from diagonally below.
b) A module (1.13) of the device, consisting of a first module part (1.16) and second module part (1.17).

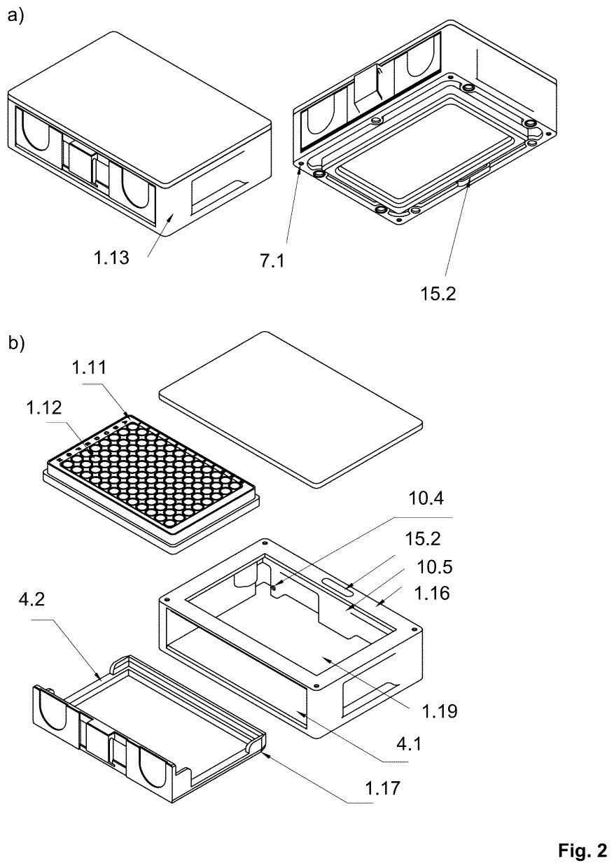

FIG. 3: a) Schematic overview of the frame underside (9.2) and frame top (9.3) of a frame (9.1) according to the current invention.
b) a Frame (9.1) With Quadrants (1.5, 1.6, 1.7).
c) A frame (9.1) with electrically communicating connections (15.2) and bus connections (16.1).

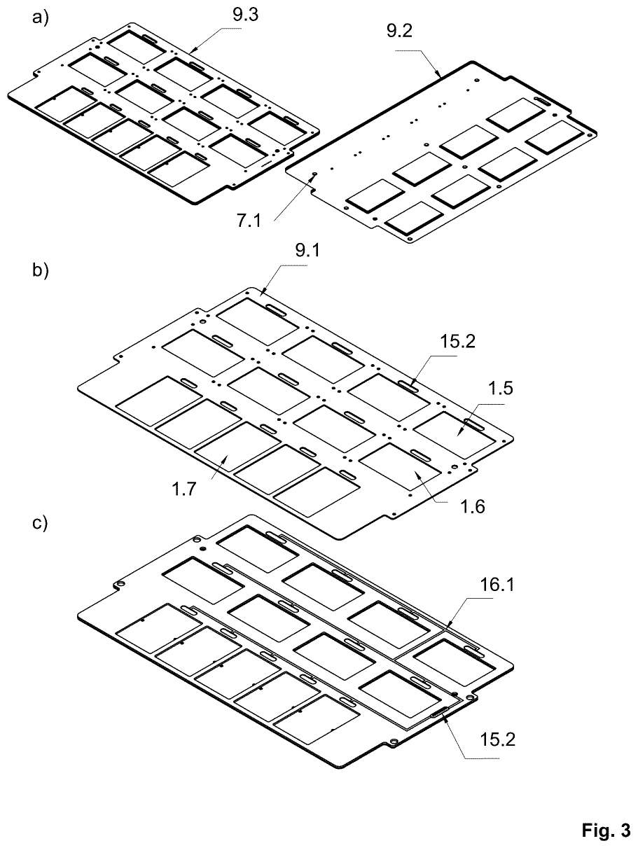

FIG. 4: A first movable actuator (1.9) with a transport unit (4.2), left: attached, right detached.

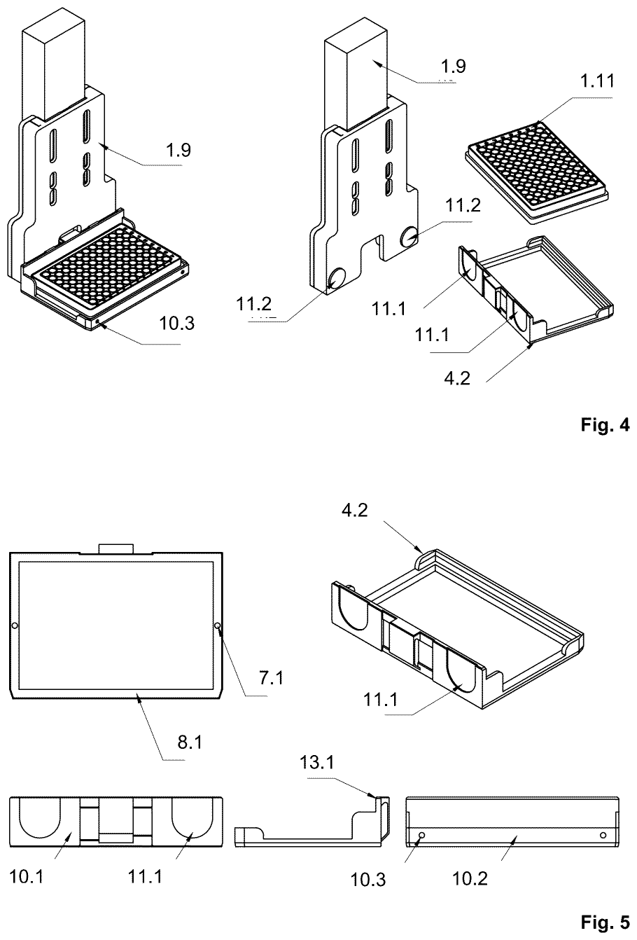

FIG. 5: A transport unit (4.2), top left: view from underside (8.1), top right: view from diagonally above, bottom left: front (10.1), bottom center: side view, bottom right: rear side (10.2).

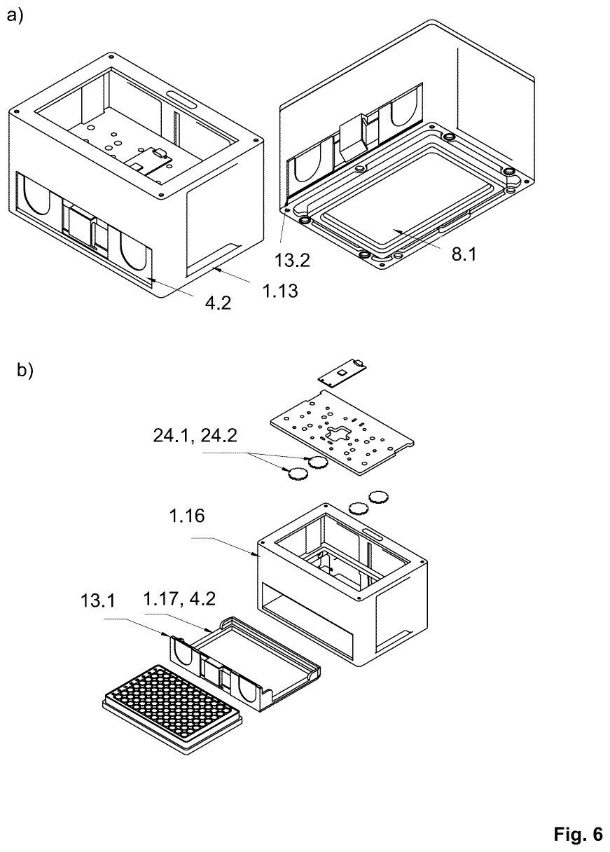

FIG. 6: a) A module (1.13) with inserted transport unit (4.2). Left: view from diagonally above, right: view from diagonally below.
b) A first module part (1.16) and a transport unit (4.2) separated from each other.

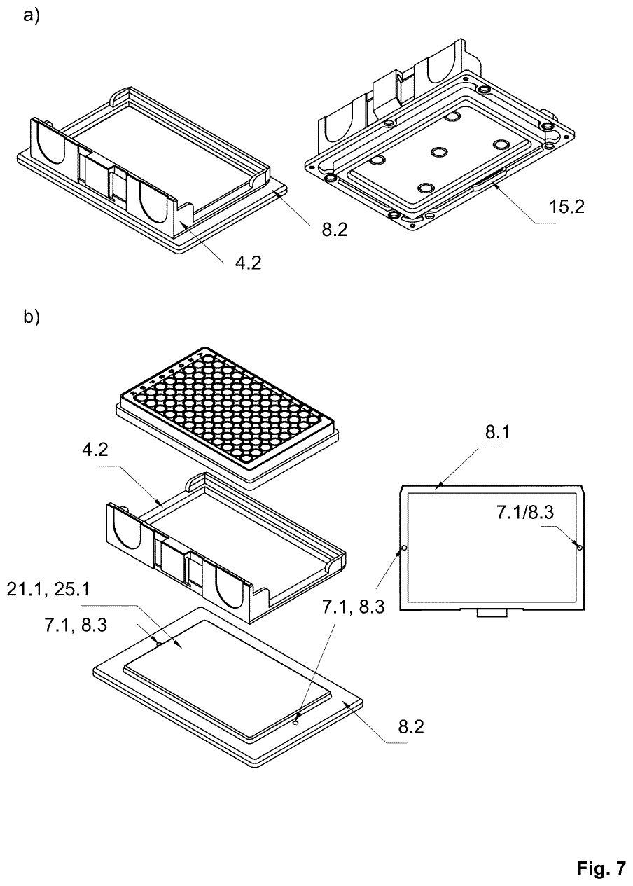

FIG. 7: a) A transport unit (4.2) arranged on a module carrier (8.2). Left: view from diagonally above, right: view from diagonally below.
b) A transport unit (4.2) on a on a module carrier (8.2) comprising a vibrating surface (21.1):

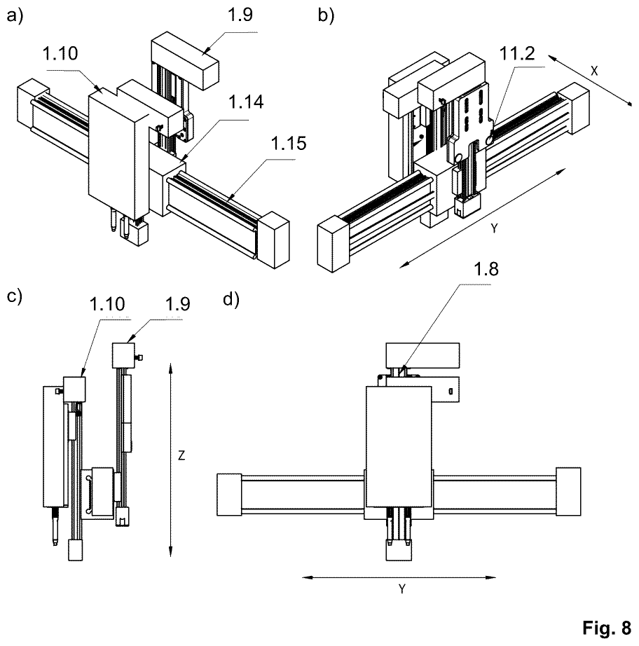

FIG. 8: a) A movable actuator system (1.8) comprising a first movable actuator (1.9). a second movable actuator (1.10), a trolley (1.14) and a kinematic system (1.15).
b) A movable actuator system (1.8) with X-Y spatial axis displayed.
c) A movable actuator system (1.8) with Z spatial axis displayed; side view.
d) A movable actuator system (1.8) with Z spatial axis displayed; front view.

In FIG. 1A an embodiment of the device according to the invention is shown, the components involved being shown schematically, wherein the device according to the current invention is placed inside the sterile work area (14.2) of a sterile workbench (14.1), so that experiments can advantageously be carried out in a sterile working environment. FIG. 1B shows an example of the device (1.1) according to the current invention with a base (16.2) and human machine interface (16.3), which allows a human to interact with the device. FIG. 1C shows an exemplary configuration of the device according to the invention without enclosure. This embodiment of the device according to the invention is subdivided into areas (1.2) divided into quadrants (1.5, 1.6), including a working area (1.3) and a front loader area (1.4), which are allocated on a base surface (7.2) of the device. The exemplary device incorporates a movable actuator system (1.8) attached to a trolley (1.14) connected to a kinematic system (1.15), which advantageously allows the transport of sample carriers between modules and quadrants. This has the technical advantage that different experiments can be performed under defined conditions in different modules. A first movable actuator (1.9) transports a sample carrier (1.11) with at least one cavity between quadrants (1.5, 1.6). The device includes a module (1.13) for receiving and storing the sample carrier, realized as a two-part structure with a storage unit (1.18). The storage units in this embodiment are shown stacked on top of another, which increases storage capacity. A second movable actuator (1.10) fills or partially removes volumes of chemical substances or biological materials in the cavity (1.12), in this exemplary embodiment advantageously while the cavity resides in the working area. This has the effect of easy accessibility and a quick filling process. A further module (15.1) allows for sample storage, for example the cultivation of a cell culture.

FIG. 2 shows an example of a module (1.13) of the device according to the current invention (a), which comprises a magnetic positioning means (7.1) and an electrically communicating connection (15.2). The magnetic positioning means allow for fixation and release of the module and the electrically communicating connection (15.2) allows for communication of the module with a controller or can transmit power. The module (1.13) of the device consists of a first module part (1.16) and second module part (1.17), the second module part is realized as a transport unit (4.2), which is capable of transporting a sample carrier (1.11) with at least one cavity (1.12). The first module part (1.16) provides an opening (4.1) which is set up to allow the second module (1.17) to be partially or completely inserted. Furthermore, the first module (1.16) is adapted with a second magnetic means (10.4) located on a surface (10.5) of the interior space (1.19). It provides an electrically communicating connection (15.2), which allows the communication or power transmission to further, stacked modules (1.13). This has the advantage of allowing for a compact arrangement of the modules (1.13) without the need for cables.

FIG. 3. shows an example of a frame underside (9.2) and frame top (9.3) of a frame (9.1) according to the current invention. The frame (9.1) comprises quadrants (1.5, 1.6, 1.7) which are at least partially framed by the frame (9.1). The frame (9.1) is raised with respect to the base surface (7.2) of the device (1.1), therefore creating a physical barrier between the quadrants. In this exemplary embodiment, the frame underside (9.2) is equipped with magnetic positioning means (7.1) able to fix the frame (9.1) to the base surface (7.2). This allows for easy and quick removal of the frame (9.1) for cleaning and allows the readily exchange with frames with a different layout. The frame provides electrically communicating connections (15.2) and a bus connection (16.1), which allows a communication and power transmission without the need for cables.

FIG. 4. shows an example of a first movable actuator (1.9) with a transport unit (4.2), which is equipped to receive a sample carrier (1.11), and which can be attached to (left) or detached from (right) the first movable actuator (1.9). The first movable actuator (1.9) provides fourth magnetic means (11.2), which can be fixed to the third magnetic means (11.1) provided by the transport unit (4.2). In this example, the transport unit (4.2) further is equipped with first magnetic means (10.3).

FIG. 5. Shows an example of a transport unit (4.2), which is equipped with first magnetic means (10.3), located on the rear side (10.2) and third magnetic means (11.1), located on the front side (10.1). This allows the transport unit to be reversibly fixed, for example, to a first movable actuator (1.9) and/or a storage unit (1.18), which advantageously enables secure, fast and space-saving fixation. This embodiment of a transport unit furthermore features an edge (13.1) which may fit to the opening (4.1) of a storage unit (1.18).

FIG. 6. shows an example of a module (1.13), in which a transport unit (4.2) is inserted (a). This embodiment, the storage unit and/or the transport unit feature a sealing element (13.2), which fits to the edge (13.1) of a transport unit (4.2) which is designed to seal off the interior space (1.19) of the module (1.13). In this way, it can be advantageously achieved that contamination of the interior space (1.19) is avoided. Alternatively, a gas composition inside the module (1.13) can be manipulated so that special experiments can be performed. Additionally, the further module provides further sensors (24.1) and/or actors (24.2), this allows that the physical conditions of an experiment can be controlled, measured and manipulated in order to give optimized conditions.

FIG. 7. shows an example of a transport unit (4.2) on a on a module carrier (8.2) comprising a vibrating surface (21.1). The transport unit (4.2) is placed and fixated using opposing positioning means (8.3) in the form of magnetic positioning means (7.1) located on the module carrier (8.2) and the underside (8.1) of the transport unit (4.2). This allows for example the content of a sample carrier (1.11) to be vibrated while fixing the transport unit (4.2). It is advantageous that a container placed on the vibrating surface can be continuously shaken so that the contained liquid remains mixed. This prevents, for example, cell populations from settling within the liquid or suspension during the time the cavities are filled. Furthermore, the module carrier provides an electrically communicating connection (15.2), allowing a module to be connected.

FIG. 8. shows an example of a movable actuator system (1.8) comprising a first movable actuator (1.9). a second movable actuator (1.10), a trolley (1.14) and a kinematic system (1.15) with the X-Y-Z spatial axis displayed. Advantageously, the movable actuator system according to this example and in accordance with the current invention can be moved in the three spatial axes x, y, and z. The system consisting of two different moving actuators (1.9, 1.10) enables efficient operation of the moving actuator system (1.8) by moving, for example, transport units (4.2) or liquids for chemical and/or biological experiments. This reduces the space requirement since the transport and manipulation are carried out with the aid of the movable actuator system (1.8).

### REFERENCE LIST

1.1 automated device
1.2 areas
1.3 working area
1.4 front loader area
1.5 first quadrant
1.6 second quadrant
1.7 further quadrant
1.8 movable actuator system
1.9 first movable actuator
1.10 second movable actuator
1.11 sample carrier
1.12 cavity
1.13 module
1.14 trolley
1.15 kinematic system
1.16 first module part
1.17 second module part
1.18 storage unit
1.19 interior space
4.1 opening
4.2 transport unit
7.1 magnetic positioning means
7.2 base surface
8.1 underside
8.2 module carrier
8.3 opposing positioning means
9.1 frame
9.2 frame underside
9.3 frame top
10.1 front side
10.2 rear side
10.3 first magnetic means
10.4 second magnetic means
10.5 surface of the interior space
11.1 third magnetic means
11.2 fourth magnetic means
13.1 edge
13.2 sealing element
14.1 sterile workbench
14.2 sterile work area
15.1 one further module
15.2 electrically communicating connection
16.1 bus connection
16.2 base
16.3 human machine interface
21.1 vibrating surface
24.1 further sensor
24.2 actor
25.1 thermal surface

1-15. (canceled)

16. A module (1.13), set up to receive and store a sample carrier (1.11) used in chemical and/or biological experiments,
wherein the module (1.13) comprises at least one first module part (1.16) and at least one second module part (1.17),
wherein the first module part (1.16) is set up as a storage unit (1.18) having an interior space (1.19), the interior space (1.19) being set up to store the sample carrier (1.11),
wherein the first module part (1.16) has an opening (4.1),
wherein the second module part (1.17) is configured as a transport unit (4.2) and is set up to be in operative connection with the first module part (1.16) and a movable actuator system (1.8),
wherein the transport unit (4.2) comprises a front side (10.1) and a rear side (10.2) located opposite to the front side (10.1),
wherein the front side (10.1) is set up to be contacted by a first movable actuator (1.9),
wherein the second module part (1.17) is set up to be completely or partially inserted in or removed from the first module part (1.16) through the opening (4.1) by the movable actuator (1.9),
the front side (10.1) of the second module part (1.17) has at least a third magnetic means (11.1) that is set up to be contacted by at least a fourth magnetic means (11.2) arranged on the first movable actuator (1.9) for the purpose of transporting the second module part (1.17),
characterized in that
the module (1.13) is set up to be stacked on top of another module (1.13), wherein the modules (1.13, 1.13) can be placed on top of each other,
wherein the module (1.13) can be connected to a base surface of a device (1.1) and to at least one further module (15.1) via an electrically communicating connection (15.2),
wherein the electrically communicating connection (15.2) is set up for the transmission of data and/or electrical energy between the module (1.13) and the base surface (7.2) and between the module (1.13) and the further module (15.1),
wherein the module (1.13) has at least one electrical load and requires electrical energy which is provided via the electrically communicating connection.

17. The module of claim 16, wherein on an underside of the module (1.13) at least one opposing magnetic positioning means (7.1) is arranged which is set up to align and fix the module (1.13) within a quadrant (1.5, 1.6, 1.7).

18. The module of claim 16 wherein the module (1.13) is set up to be arranged on a module carrier to vary the position of the module (1.13) in an height relative to a base surface (7.2).

19. The module of claim 16, wherein the rear side (10.2) comprises at least a first magnetic means (10.3) that is set up to be contacted by a second magnetic means (10.4) located on a surface (10.5) of the interior space (1.19) of the storage unit (1.18) opposite to the rear side (10.2) for the purpose of fixing the second module part (1.17) within the first module part (1.16).

20. The module of claim 16, wherein the module (1.13) can be connected to at least one further module (15.1), in particular via an electrically communicating connection (15.2), wherein the electrically communicating connection (15.2) is set up for the transmission of data and/or electrical energy between the module (1.13) and the further module (15.1), whereby the electrically communicating connection (15.2) is designed as a bus connection or a magnetic connection, whereby the electrically communicating connection (15.2) is established by the correct positioning of the module (1.13) on a quadrant (1.5, 1.6, 1.7), for example brought about by the operative connection of a magnetic positioning means with an opposing positioning means on the underside of the module (1.13).

21. The module of claim 16, wherein the module (1.13) comprises a crosslinking means, which is arranged within the module (1.13) and is designed to crosslink chemical substances, in particular proteins, present in a cavity (1.12) of the sample carrier (1.11), with one another.

22. The module of claim 16, wherein the first module part (1.16) is set up to adjust a temperature within the interior space (1.19) of the storage unit (1.18), whereby the temperature is unequal or equal to the temperature outside the storage unit (1.18).

23. The module of claim 16, wherein a sealing element (13.2) is positioned along the opening (4.1), whereby the sealing element (13.2) is set up to reduce the risk of contamination of the interior space (1.19) and/or to reduce or prevent gas exchange between the interior space (1.19) and the space outside the storage unit (1.18).
